(19) United States
(12) Patent Application Publication
(10) Pub. No.: US 2020/0249022 A1
(43) Pub. Date: Aug. 6, 2020

(54) INERTIAL SENSOR, ELECTRONIC DEVICE, AND VEHICLE

(71) Applicant: SEIKO EPSON CORPORATION, Tokyo (JP)

(72) Inventor: Kazuyuki NAGATA, MINOWA-MACHI (JP)

(21) Appl. No.: 16/774,745

(22) Filed: Jan. 28, 2020

(30) Foreign Application Priority Data
Jan. 31, 2019 (JP) 2019-015333

(51) Int. Cl. G01C 19/5705

(52) U.S. Cl. CPC G01C 19/5705

(57) ABSTRACT

An inertial sensor according to an embodiment includes, when three axes orthogonal to one another are represented as an X axis, a Y axis, and a Z axis, a substrate, a movable body configured to swing around a swing axis extending along the Y axis, a fixed section configured to support the movable body and fixed to the substrate, and a stopper fixed to the substrate and configured to come into contact with the movable body to thereby restrict rotational displacement of the movable body around the Z axis. A stopper joining region where the stopper and the substrate are jointed is located, in a plan view from a direction along the Z axis, within a first region formed by extending the movable body in a direction along the Y axis, and a portion of the stopper located outside the first region is separated from the substrate.

The present application is based on, and claims priority from JP Application Serial Number 2019-015333, filed Jan. 31, 2019, the disclosure of which is hereby incorporated by reference herein in its entirety.

### BACKGROUND

### 1. Technical Field

The present disclosure relates to an inertial sensor, an electronic device, and a vehicle.

### 2. Related Art

For example, an inertial sensor described in JP A-2015-017886 (Patent Literature 1) is a sensor capable of detecting acceleration in a Z-axis direction. The inertial sensor includes a substrate, a movable body that swings in a seesaw manner around a swing axis extending along a Y-axis direction with respect to the substrate, and a fixed detection electrode provided on the substrate. The movable body includes a first movable section and a second movable section provided across the swing axis and having rotational moments around the swing axis different from each other. The fixed detection electrode includes a first fixed detection electrode disposed on the substrate to be opposed to the first movable section of the movable section and a second fixed detection electrode disposed on the substrate to be opposed to the second movable section of the movable section.

In the inertial sensor having such a configuration, when the acceleration in the Z-axis direction is applied, the movable body swings in a seesaw manner around the swing axis. According to the seesaw swinging of the movable body, capacitance between the first movable section and the first fixed detection electrode and capacitance between the second movable section and the second fixed detection electrode change in opposite phases each other. Therefore, it is possible to detect the acceleration in the Z-axis direction based on the change in the capacitances.

The inertial sensor described in Patent Literature 1 includes a stopper fixed to the substrate and for suppressing rotational displacement of the movable body.

However, in the inertial sensor described in Patent Literature 1, the stopper is fixed to the substrate in a position farther from the swing axis than the movable body. Therefore, when a warp occurs in the substrate because of thermal expansion or the like, the stopper is easily displaced with respect to the movable body because of the warp. An amount of the displacement tends to be large. Therefore, for example, it is likely that the stopper excessively approaches the movable body and hinders the swing of the movable body around the swing axis. Conversely, it is likely that the stopper excessively separates from the movable body, the movable body does not come into contact with the stopper even if the movable body is rotationally displaced, and the stopper cannot exert the function of the stopper.

### SUMMARY

An inertial sensor according to an embodiment includes, when three axes orthogonal to one another are represented as an X axis, a Y axis, and a Z axis, a substrate; a movable body configured to swing around a swing axis extending along the Y axis; a fixed section configured to support the movable body and fixed to the substrate; and a stopper fixed to the substrate and configured to come into contact with the movable body to thereby restrict rotational displacement of the movable body around the Z axis. A stopper joining region where the stopper and the substrate are jointed is located, in a plan view from a direction along the Z axis, within a first region formed by extending the movable body in a direction along the Y axis, and a portion of the stopper located outside the first region is separated from the substrate.

### BRIEF DESCRIPTION OF THE DRAWINGS

FIG. 1 is a plan view showing an inertial sensor according to a first embodiment.

FIG. 2 is a sectional view taken along an A-A line in FIG. 1.

FIG. 3 is a sectional view taken along a B-B line in FIG. 1.

FIG. 4 is a plan view showing a sensor element and a fixing section of a stopper to a substrate.

FIG. 5 is a sectional view for explaining problems of a configuration in the past.

FIG. 6 is a sectional view for explaining effects of the embodiment.

FIG. 7 is a plan view showing a modification of the inertial sensor shown in FIG. 1.

FIG. 8 is a plan view showing a modification of the inertial sensor shown in FIG. 1.

FIG. 9 is a plan view showing a modification of the inertial sensor shown in FIG. 1.

FIG. 10 is a plan view showing a modification of the inertial sensor shown in FIG. 1.

FIG. 11 is a plan view showing a modification of the inertial sensor shown in FIG. 1.

FIG. 12 is a plan view showing a modification of the inertial sensor shown in FIG. 1.

FIG. 13 is a plan view showing an inertial sensor according to a second embodiment.

FIG. 14 is a sectional view taken along a C-C line in FIG. 13.

FIG. 15 is a plan view showing a smartphone functioning as an electronic device according to a third embodiment.

FIG. 16 is an exploded perspective view showing an inertial measurement unit functioning as an electronic device according to a fourth embodiment.

FIG. 17 is a perspective view of a substrate included in the inertial measurement unit shown in FIG. 16.

FIG. 18 is a block diagram showing an entire system of a movable body positioning device functioning as an electronic device according to a fifth embodiment.

FIG. 19 is a diagram showing action of the vehicle positioning device shown in FIG. 18.

FIG. 20 is a perspective view showing a vehicle according to a sixth embodiment.

### DESCRIPTION OF EXEMPLARY EMBODIMENTS

An inertial sensor, an electronic device, and a vehicle according to the present disclosure are explained in detail below based on embodiments shown in the accompanying drawings.

### First Embodiment

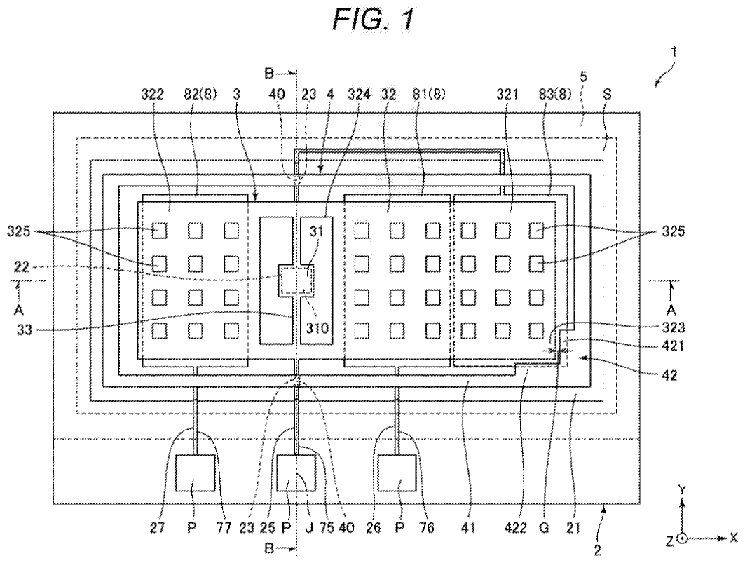

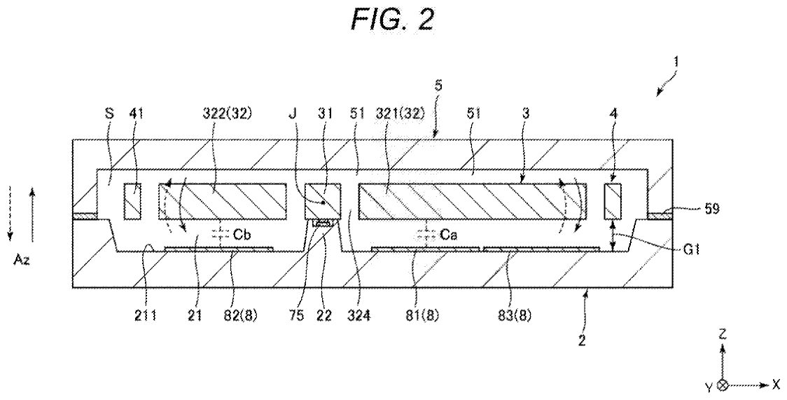

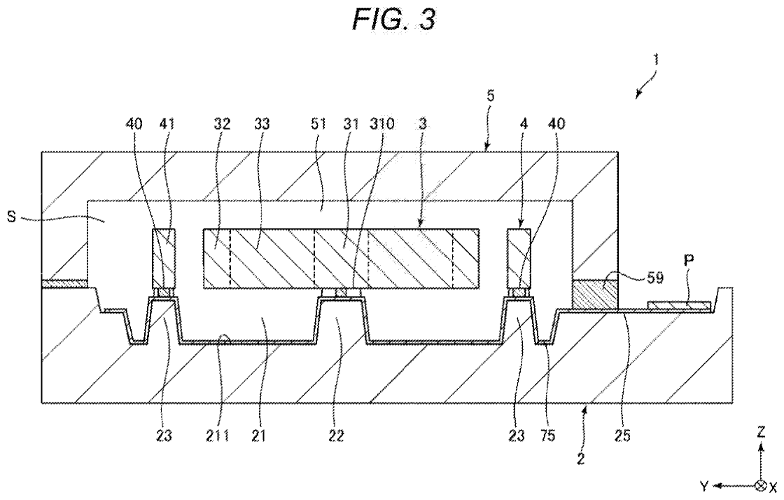

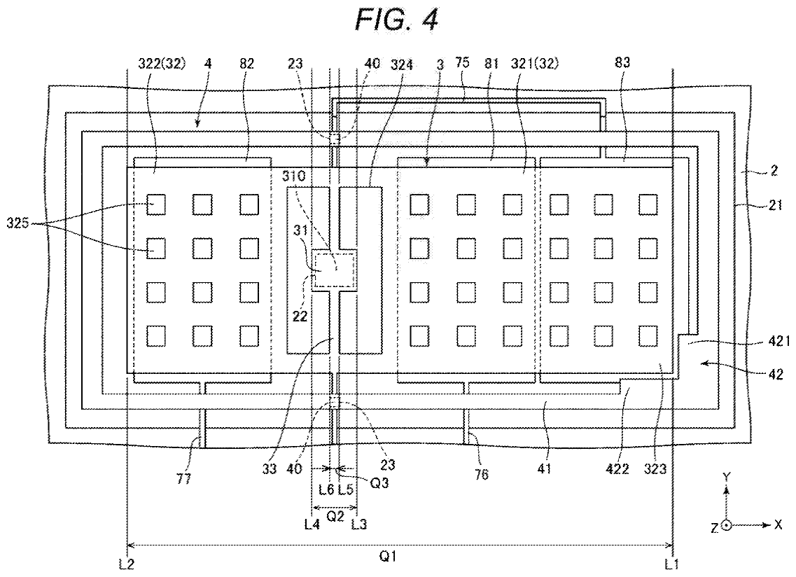

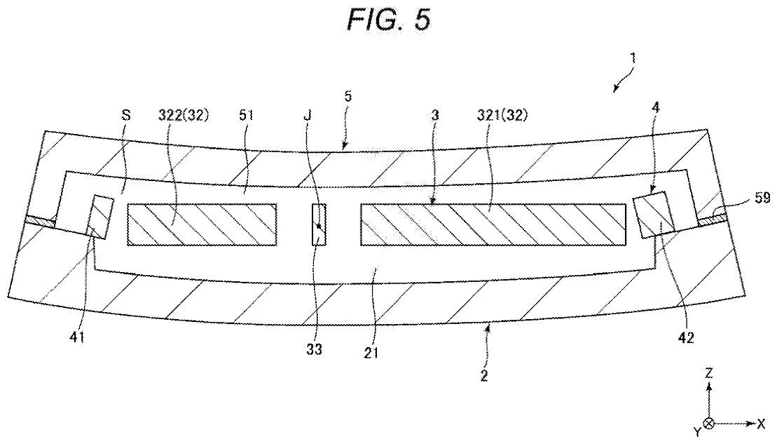

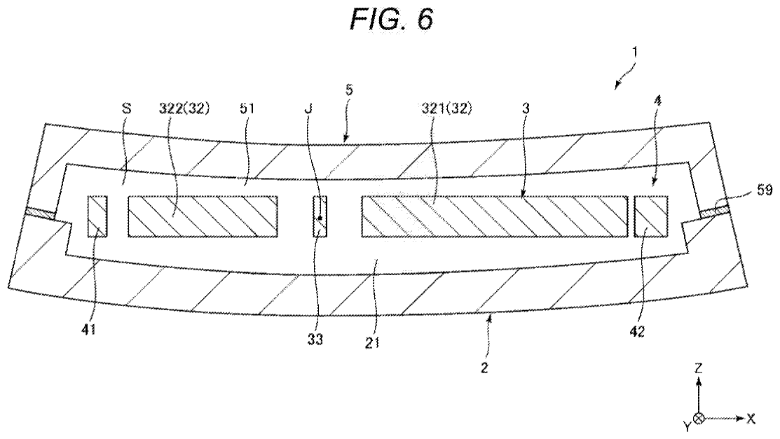

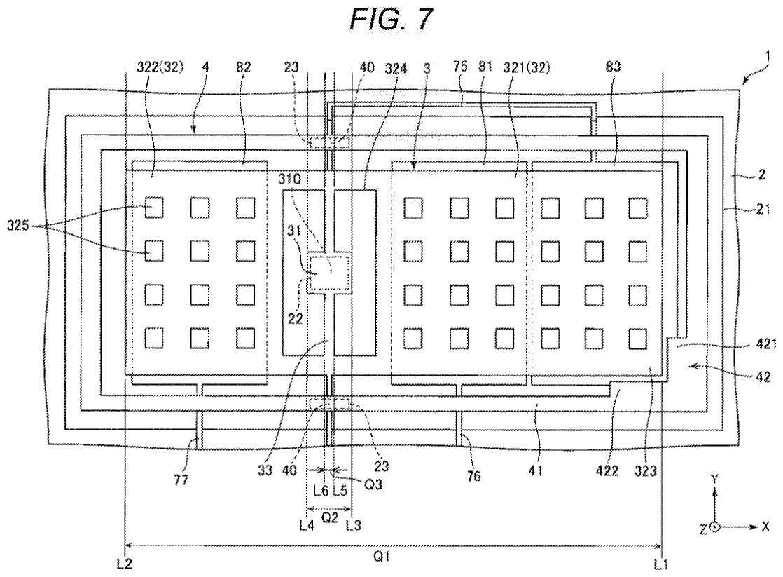

FIG. 1 is a plan view showing an inertial sensor according to a first embodiment. FIG. 2 is a sectional view taken along an A-A line in FIG. 1. FIG. 3 is a sectional view taken along a B-B line in FIG. 1. FIG. 4 is a plan view showing a sensor element and a fixing section of a stopper to a substrate. FIG. 5 is a sectional view for explaining problems of a configuration in the past. FIG. 6 is a sectional view for explaining effects of the embodiment. FIGS. 7 to 12 are respectively plan views showing modifications of the inertial sensor shown in FIG. 1.

In the following explanation, for convenience of explanation, three axes orthogonal to one another are represented as an X axis, a Y axis, and a Z axis. A direction along the X axis, that is, a direction parallel to the X axis is referred to as “X-axis direction” as well, a direction parallel to the Y axis is referred to as “Y-axis direction” as well, and a direction parallel to the Z axis is referred to as “Z-axis direction” as well. An arrow direction distal end side of the axes is referred to as “plus side” as well and the opposite side is referred to as “minus side” as well. A Z-axis direction plus side is referred to as “upper” and a Z-axis direction minus side is referred to as “lower”. In this specification, “orthogonal” includes, besides the axes crossing at 90°, the axes crossing at an angle slightly tilting from 90°, for example, the axes crossing in a range of, for example, approximately 90°±5°. Similarly, “parallel” includes, besides the axes forming an angle of 0°, the axes having a difference within a range of approximately ±5°.

An inertial sensor 1 shown in FIG. 1 is an acceleration sensor that detects acceleration Az in the Z-axis direction. Such an inertial sensor 1 includes a substrate 2, a sensor element 3 disposed on the substrate 2, a stopper 4 configured to suppress unnecessary displacement of the sensor element 3, and a lid 5 joined to the substrate 2 to cover the sensor element 3 and the stopper 4.

As shown in FIG. 1, the substrate 2 includes a recess 21 opened to the upper surface side. In a plan view from the Z-axis direction, the recess 21 is formed larger than the sensor element 3 and the stopper 4 to include the sensor element 3 and the stopper 4 on the inner side. As shown in FIGS. 2 and 3, the substrate 2 includes a first mount 22 and a second mount 23 having a protrusion shape provided to project from a bottom surface 211 of the recess 21. The sensor element 3 is joined to the upper surface of the first mount 22. The stopper 4 is joined to the upper surface of the second mount 23. As shown in FIG. 1, the substrate 2 includes grooves 25, 26, and 27 opened to the upper surface side.

As the substrate 2, a glass substrate configured by a glass material including an alkali metal ion, which is a movable ion such as Na+, for example, borosilicate glass such as Pyrex glass or Tempax glass (both of which are registered trademarks) can be used. However, the substrate 2 is not particularly limited. For example, a silicon substrate or a ceramic substrate may be used.

As shown in FIG. 1, electrodes 8 are provided on the substrate 2. The electrodes 8 include a first fixed detection electrode 81, a second fixed detection electrode 82, and a dummy electrode 83 disposed on the bottom surface 211 of the recess 21. The substrate 2 includes wires 75, 76, and 77 disposed in the grooves 25, 26, and 27.

One end portions of the wires 75, 76, and 77 are exposed to the outside of the lid 5 and function as electrode pads P that perform electric coupling to external devices. The wire 75 is electrically coupled to the sensor element 3, the stopper 4, and the dummy electrode 83. The wire 76 is electrically coupled to the first fixed detection electrode 81. The wire 77 is electrically coupled to the second fixed detection electrode 82.

As shown in FIG. 2, the lid 5 includes a recess 51 opened to the lower surface side. The lid 5 is joined to the upper surface of the substrate 2 to house the sensor element 3 and the stopper 4 in the recess 51. A housing space S for housing the sensor element 3 and the stopper 4 is formed by the lid 5 and the substrate 2 on the inner side thereof. The housing space S is an airtight space. An inert gas such as nitrogen, helium, or argon is encapsulated in the housing space S. The housing space S desirably has a substantially atmospheric pressure at a working temperature (approximately −40° to 120°). However, the atmosphere in the housing space S is not particularly limited and may be, for example, a decompressed state or may be a pressurized state.

As the lid 5, for example, a silicon substrate can be used. However, the lid 5 is not particularly limited. For example, a glass substrate or a ceramic substrate may be used. A joining method of the substrate 2 and the lid 5 is not particularly limited. The joining method only has to be selected as appropriate according to materials of the substrate 2 and the lid 5. For example, anodic joining, activation joining for joining surfaces activated by plasma radiation, joining by a joining material such as glass frit, or diffused joining for joining metal films formed on the upper surface of the substrate 2 and the lower surface of the lid 5. In this embodiment, the substrate 2 and the lid 5 are joined by glass frit 59 formed by low-melting point glass.

The sensor element 3 is formed by patterning, with a Bosch process, which is an etching or deep groove etching technique, a conductive silicon substrate doped with impurities such as phosphorus (P), boron (B), or arsenic (As). The sensor element 3 includes, as shown in FIG. 1, a fixed section 31 joined to the upper surface of the first mount 22, a movable body 32 swingable around, with respect to the fixed section 31, a swing axis J extending along the Y axis, and a beam 33 configured to couple the fixed section 31 and the movable section 32. The first mount 22 and the fixed section 31 are, for example, anodically joined.

The movable body 32 is formed in a rectangular shape longitudinal in the X-direction in the plan view from the Z-axis direction. The movable body 32 includes a first movable section 321 and a second movable section 322 disposed across the swing axis J in the plan view from the Z-axis direction. The first movable section 321 is located at an X-axis direction plus side with respect to the swing axis J. The second movable section 322 is located at an X-axis direction minus side with respect to the swing axis J. The first movable section 321 is longer in the X-axis direction than the second movable section 322. A rotational moment of the first movable section 321 around the swing axis J at the time when the acceleration Az is applied thereto is larger than the rotational moment of the second movable section 322. According to a difference between the rotational moments, the movable body 32 swings in a seesaw manner around the swing axis J when the acceleration Az is applied thereto. The seesaw swinging means that, when the first movable section 321 is displaced to a Z-axis direction plus side, the second movable section 322 is displaced to a Z-axis direction minus side and, conversely, when the first movable section 321 is displaced to the Z-axis direction minus side, the second movable section 322 is displaced to the Z-axis direction plus side.

The movable body 32 includes a plurality of through-holes 325 piercing through the movable body 32 in the thickness direction. The movable body 32 includes an opening 324 located between the first movable section 321 and the second movable section 322. The fixed section 31 and the beam 33 are disposed in the opening 324. It is possible to achieve a reduction in the size of the sensor element 3 by disposing the fixed section 31 and the beam 33 on the inner side of the movable body 32 in this way. However, the through-holes 325 may be omitted. The disposition of the fixed section 31 and the beam 33 is not particularly limited. For example, as in another embodiment explained below, the fixed section 31 and the beam 33 may be located at the outer side of the movable body 32.

The electrodes 8 disposed on the bottom surface 211 of the substrate 2 are explained again. As shown in FIGS. 1 and 2, the first fixed detection electrode 81 is disposed to be opposed to the proximal end portion of the first movable section 321, the second fixed detection electrode 82 is disposed to be opposed to the second movable section 322, and the dummy electrode 83 is disposed to be opposed to the distal end portion of the first movable section 321. In other words, in the plan view from the Z-axis direction, the first fixed detection electrode 81 is disposed to overlap the proximal end portion of the first movable section 321, the second fixed detection electrode 82 is disposed to overlap the second movable section 322, and the dummy electrode 83 is disposed to overlap the distal end portion of the first movable section 321.

During driving of the inertial sensor 1, a driving voltage is applied to the sensor element 3 via the wire 75. The first fixed detection electrode 81 and a QV amplifier are coupled by the wire 76. The second fixed detection electrode 82 and another QV amplifier are coupled by the wire 77. Consequently, capacitance Ca is formed between the first movable section 321 and the first fixed detection electrode 81. Capacitance Cb is formed between the second movable section 322 and the second fixed detection electrode 82.

When the acceleration Az is applied to the inertial sensor 1, the movable body 32 swings in a seesaw manner around the swing axis J. According to this seesaw swinging of the movable body 32, a gap between the first movable section 321 and the first fixed detection electrode 81 and a gap between the second movable section 322 and the second fixed detection electrode 82 change in opposite phases each other. The capacitances Ca and Cb change in opposite phases each other according to the change of the gaps. Therefore, the inertial sensor 1 can detect the acceleration Az based on a difference (an amount of change) between the capacitances Ca and Cb.

The stopper 4 has a function of suppressing unnecessary displacement other than the seesaw swinging of the movable body 32 around the swing axis J explained above, in particular, displacement in the X-axis direction, displacement in the Y-axis direction, and displacement in an X-Y in-plane direction such as rotational displacement around the Z axis centering on the fixed section 31. By providing such a stopper 4, it is possible to effectively suppress excessive displacement in an unnecessary direction of the movable body 32. It is possible to effectively suppress breakage of the sensor element 3. Such a stopper 4 is formed by patterning, with a Bosch process, which is an etching or deep groove etching technique, a conductive silicon substrate doped with impurities such as phosphorus (P), boron (B), or arsenic (As). In particular, in this embodiment, the sensor element 3 and the stopper 4 are collectively formed from the same silicon substrate. Consequently, it is easy to form the stopper 4.

As explained above, like the sensor element 3, the stopper 4 is electrically coupled to the wire 75. Therefore, the stopper 4 and the sensor element 3 have the same potential. It is substantially unlikely that parasitic capacitance and electrostatic attraction occur between the stopper 4 and the sensor element 3. Therefore, it is possible to effectively suppress deterioration in a detection characteristic of the acceleration Az due to the stopper 4. However, not only this, but the stopper 4 does not have to have the same potential as the potential of the sensor element 3. For example, the stopper 4 may have the ground potential or may be electrically floating.

As shown in FIG. 1, the stopper 4 includes a frame-like supporting section 41 surrounding the periphery of the sensor element 3 in the plan view from the Z-axis direction and a stopper main body 42 located at the inner side of the supporting section 41 and supported by the supporting section 41. Such a stopper 4 is formed smaller than the recess 21 and included on the inner side of the recess 21 in the plan view from the Z-axis direction.

The stopper main body 42 is disposed to be opposed to one corner section 323 located at the distal end portion of the first movable section 321 of the movable body 32. A gap G enough for allowing the seesaw swinging of the movable body 32 around the swing axis J is formed between the movable body 32 and the stopper main body 42. The corner section 323 is located most distant from the fixed section 31 in the movable body 32 and has the largest displacement amount when the rotational displacement around the Z axis explained above occurs. Therefore, since the stopper main body 42 is formed to be opposed to the corner section 323, the movable body 32 easily comes into contact with the stopper main body 42. The stopper 4 can more surely exert the effects of the stopper 4. Since the gap G can also be formed relatively large, it is easy to form the stopper 4 and manage the gap G. The size of the gap G is not particularly limited and can be set to, for example, approximately 1 to 5 μm depending on, for example, the size of the sensor element 3.

The stopper main body 42 includes an X-displacement restricting section 421 opposed to the corner section 323 in the X-axis direction and a Y-displacement restricting section 422 opposed to the corner section 323 in the Y-axis direction. For example, when the movable body 32 is displaced in the X-axis direction, the corner section 323 comes into contact with the X-displacement restricting section 421 and further displacement of the movable body 32 is restricted. When the movable body 32 is displaced in the Y-axis direction, the corner section 323 comes into contact with the Y-displacement restricting section 422 and further displacement of the movable body 32 is restricted. When the movable body 32 is rotationally displaced around the Z axis, the corner section 323 comes into contact with the X-displacement restricting section 421 or the Y-displacement restricting section 422 and further displacement of the movable body 32 is restricted. The gap G between the X-displacement restricting section 421 and the movable body 32 and the gap between the Y-displacement restricting section 422 and the movable body 32 may be equal or may be different. The X-displacement restricting section 421 and the Y-displacement restricting section 422 do not need to be coupled to each other as shown in FIG. 1 and may be protrusions provided separately from each other.

As shown in FIGS. 1 and 3, the stopper 4 having such a configuration is joined to the upper surface of the second mount 23 in the supporting section 41. Stopper joining regions 40, which are joining regions of the stopper 4 and the second mount 23, are explained in detail below. The stopper 4 is separated from the substrate 2 and isolated in a portion other than the stopper joining regions 40.

The stopper joining regions 40 are provided one each on Y-axis direction both sides of the movable section 32. That is, one stopper joining region 40 is located at a Y-axis direction plus side of the movable body 32 and one stopper joining region 40 is located at a Y-axis direction minus side of the movable body 32. By providing the two stopper joining regions 40 in this way, it is possible to support the stopper 4 in a stable posture. However, the number of stopper joining regions is not particularly limited. As in an embodiment explained below, the number of stopper joining regions may be one or may be three or more.

As shown in FIG. 4, in the plan view from the Z-axis direction, when a region formed by extending the movable body 32 in the Y-axis direction is represented as a first region Q1, the stopper joining regions 40 are located within the first region Q1. A portion other than the stopper joining regions 40 of the stopper 4, in particular, a portion outside the first region Q1 is separated from the substrate 2. That is, as shown in FIG. 2, a gap G1 is formed between the lower surface of the stopper 4 and the bottom surface of the recess 21. In other words, the first region Q1 is also considered to be a region between a first imaginary line L1 passing the end on the X-axis direction plus side of the movable body 32 and parallel to the Y axis and a second imaginary line L2 passing the end on the X-axis direction minus side of the movable body 32 and parallel to the Y axis. The portion located outside the first region Q1 is a portion further on the X-axis direction plus side than the first imaginary line L1 and further on the X-axis direction minus side than the second imaginary line L2.

By disposing the stopper joining regions 40 as explained above, for example, even if a warp occurs in the substrate 2 because of a thermal expansion coefficient difference between the substrate 2 and the lid 5, positional deviation between the movable body 32 and the stopper main body 42 less easily occurs. Therefore, the stopper 4 can surely exert the function of the stopper 4 irrespective of a warp state of the substrate 2.

This is more specifically explained below. For example, as shown in FIG. 5, when the stopper 4 is fixed to the substrate 2 outside the first region Q1, the stopper main body 42 is displaced according to a warp of the substrate 2. A positional relation between the movable body 32 and the stopper main body 42 is greatly broken. When the stopper main body 42 approaches the movable body 32, the stopper main body 42 is likely to hinder the seesaw swinging of the movable body 32 around the swing axis J. Conversely, when the stopper main body 42 separates from the movable body 32, it is likely that the movable body 32 cannot come into contact with the stopper main body 42 when the movable body 32 is unnecessarily displaced in the X-Y plane. That is, the stopper 4 cannot exert the function of the stopper 4. On the other hand, as shown in FIG. 6, when the stopper 4 is fixed to the substrate 2 in the first region Q1, displacement of the stopper main body 42 involved in the warp of the substrate 2 is further suppressed than the displacement in FIG. 5. Accordingly, positional deviation between the movable section 32 and the stopper main body 42 can be suppressed. Therefore, with the inertial sensor 1 in this embodiment, the stopper 4 can more surely exert the function of the stopper 4 irrespective of the warp of the substrate 2.

As shown in FIG. 4, the stopper joining regions 40 are disposed to overlap the swing axis J in the plan view from the Z-axis direction. Consequently, it is possible to cause the stopper joining regions 40 to further approach the fixed section 31. By bringing a fixed section joining region 310, which is the joining region of the sensor element 3 and the substrate 2, and the stopper joining regions 40 close to each other in this way, the positional deviation between the fixed section joining region 310 and the stopper joining regions 40 involved in the warp of the substrate 2 further decreases. Therefore, the positional deviation of the stopper 4 with respect to the sensor element 3 is more effectively suppressed. The stopper 4 can more surely exert the function of the stopper 4 irrespective of the warp of the substrate 2.

Further, as shown in FIG. 4, when a region formed by extending the fixed section 31 in the Y-axis direction is represented as a second region Q2, the stopper joining regions 40 are located within the second region Q2. The entire region, in particular, a portion located outside the second region Q2 of the portion other than the stopper joining regions 40 of the stopper 4 is separated from the substrate 2. In other words, the second region Q2 is also considered to be a region between a third imaginary line L3 passing the end on the X-axis direction plus side of the fixed section 31 and parallel to the Y axis and a fourth imaginary line L4 passing the end on the X-axis direction minus side of the fixed section 31 and parallel to the Y axis. The portion located outside the second region Q2 is a portion further on the X-axis direction plus side than the third imaginary line L3 and further on the X-axis direction minus side than the fourth imaginary line L4. With such a configuration, the stopper joining regions 40 can be brought closer to the fixed section joining region 310 and the area of the stopper joining regions 40 further decreases. Therefore, the positional deviation between the stopper main body 42 and the movable body 32 involved in the warp of the substrate 2 is more effectively suppressed. The stopper 4 can more surely exert the function of the stopper 4 irrespective of the warp of the substrate 2.

Further, as shown in FIG. 4, when a region formed by extending the beam 33 in the Y-axis direction is represented as a third region Q3, the stopper joining regions 40 are located within the third region Q3. The entire region, in particular, a portion located at the third region Q3 side of the portion other than the stopper joining regions 40 of the stopper 4 is separated from the substrate 2. In other words, the third region Q3 is also considered to be a region between a fifth imaginary line L5 passing the end on the X-axis direction plus side of the beam 33 and parallel to the Y axis and a sixth imaginary line L6 passing the end on the X-axis direction minus side of the beam 33 and parallel to the Y axis. The portion located outside the third region Q3 is a portion further on the X-axis direction plus side than the fifth imaginary line L5 and further on the X-axis direction minus side than the sixth imaginary line L6. With such a configuration, the stopper joining regions 40 can be brought closer to the fixed section joining region 310 and the area of the stopper joining regions 40 further decreases. Therefore, the positional deviation between the stopper main body 42 and the movable body 32 involved in the warp of the substrate 2 is more effectively suppressed. The stopper 4 can more surely exert the function of the stopper 4 irrespective of the warp of the substrate 2.

The inertial sensor 1 is explained above. As explained above, when the three axes orthogonal to one another are represented as the X axis, the Y axis, and the Z axis, the inertial sensor 1 includes the substrate 2, the movable body 32 configured to swing around the swing axis J extending along the Y axis, the fixed section 31 configured to support the movable body 32 and fixed to the substrate 2, and the stopper 4 fixed to the substrate 2 and configured to come into contact with the movable body 32 to thereby restrict rotational displacement of the movable body 32 around the Z axis. The stopper joining regions 40 where the stopper 4 and the substrate 2 are joined are located, in the plan view from the direction along the Z axis, within the first region Q1 formed by extending the movable body 32 in the direction along the Y axis. The portion located outside the first region Q1 of the stopper 4 is separated from the substrate 2. By configuring the stopper 4 in this way, displacement of the stopper 4 involved in the warp of the substrate 2 is suppressed. Accordingly, it is possible to suppress positional deviation between the movable body 32 and the stopper 4. Therefore, the stopper 4 can more surely exert the function of the stopper 4 without being affected by the warp of the substrate 2.

As explained above, the stopper joining regions 40 are located, in the plan view from the direction along the Z axis, within the second region Q2 formed by extending the fixed section 31 in the direction along the Y axis. The portion located outside the second region Q2 of the stopper 4 is separated from the substrate 2. By configuring the stopper 4 in this way, the displacement of the stopper 4 involved in the warp of the substrate 2 is more effectively suppressed. Accordingly, it is possible to more effectively suppress positional deviation between the movable body 32 and the stopper 4.

As explained above, the stopper joining regions 40 overlap the swing axis J in the plan view from the direction along the Z axis. Therefore, the stopper joining regions 40 can be brought closer to the fixed section 31. The positional deviation between the fixed section joining region 310 and the stopper joining regions 40 involved in the warp of the substrate 2 further decreases. Therefore, the positional deviation of the stopper 4 with respect to the sensor element 3 is more effectively suppressed. The stopper 4 can more surely exert the function of the stopper 4 irrespective of the warp of the substrate 2.

As explained above, the sensor element 3 includes the beam 33 configured to couple the movable body 32 and the fixed section 31. The stopper joining regions 40 is located, in the plan view from the direction along the Z axis, within the third region Q3 formed by extending the beam 33 in the direction along the Y axis. The portion of the stopper 4 located outside the third region Q3 is separated from the substrate 2. By configuring the stopper 4 in this way, the displacement of the stopper 4 involved in the warp of the substrate 2 is more effectively suppressed. Accordingly, it is possible to more effectively suppress the positional deviation between the movable body 32 and the stopper 4.

As explained above, the stopper 4 is separate from the fixed section 31. The stopper joining regions 40 are present in positions different from the fixed section joining region 310 where the fixed section 31 and the substrate 2 are joined. With such a configuration, design flexibility of the sensor element 3 and the stopper 4 is improved.

As explained above, the fixed section 31 is located at the inner side of the movable body 32 in the plan view. Therefore, it is possible to achieve a reduction in the size of the sensor element 3.

As explained above, the movable body 32 includes the first movable section 321 and the second movable section 322 disposed across the swing axis J, the second movable section 322 having the rotational moment around the swing axis J different from the rotational moment of the first movable section 321. The inertial sensor 1 includes the first fixed detection electrode 81 disposed on the substrate 2 and opposed to the first movable section 321 and the second fixed detection electrode 82 disposed on the substrate 2 and opposed to the second movable section 322. With such a configuration, the inertial sensor 1 is capable of detecting the acceleration Az in the Z-axis direction. Specifically, when the acceleration Az in the Z-axis direction is applied, the movable body 32 swings along the swing axis J. According to the swinging of the movable body 32, the capacitance Ca between the first movable section 321 and the first fixed detection electrode 81 and the capacitance Cb between the second movable section 322 and the second fixed detection electrode 82 change. Therefore, it is possible to detect the acceleration Az based on the changes of the capacitances Ca and Cb.

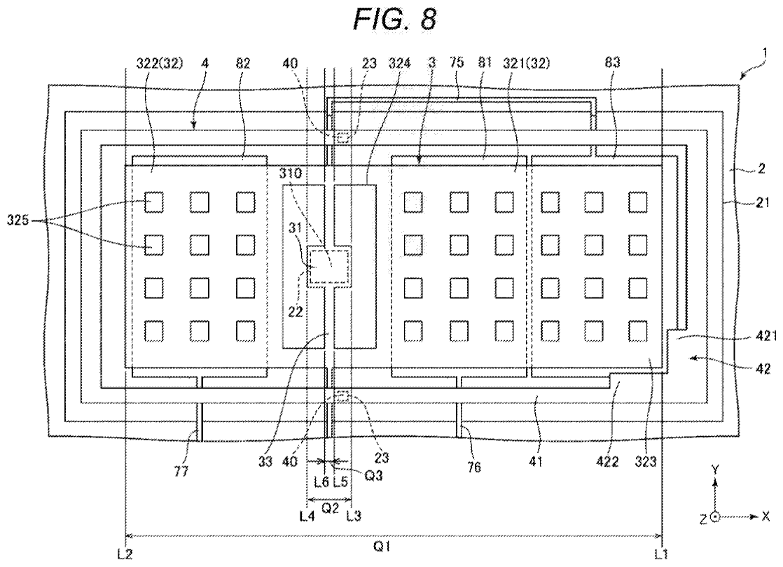

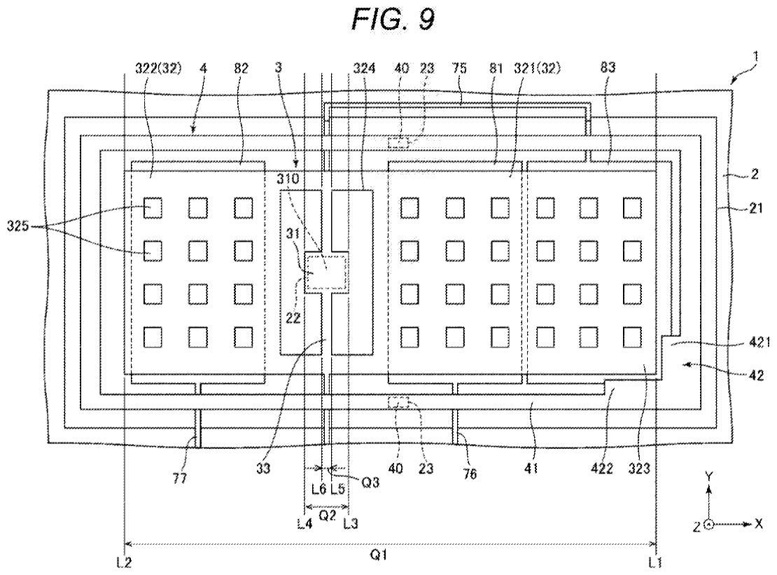

In this embodiment, the configuration is explained in which the entire regions of the stopper joining regions 40 are located within the third region Q3. However, the stopper joining regions 40 are not limited to this. For example, as shown in FIG. 7, the stopper joining regions 40 may protrude from the third region Q3 to be located within the second region Q2. As shown in FIG. 8, the stopper joining regions 40 may be located within the second region Q2 and outside the third region Q3. As shown in FIG. 9, the stopper joining regions 40 may be located within the first region Q1 and outside the second region Q2. With such configurations as well, the same effects as the effects in this embodiment can be exerted.

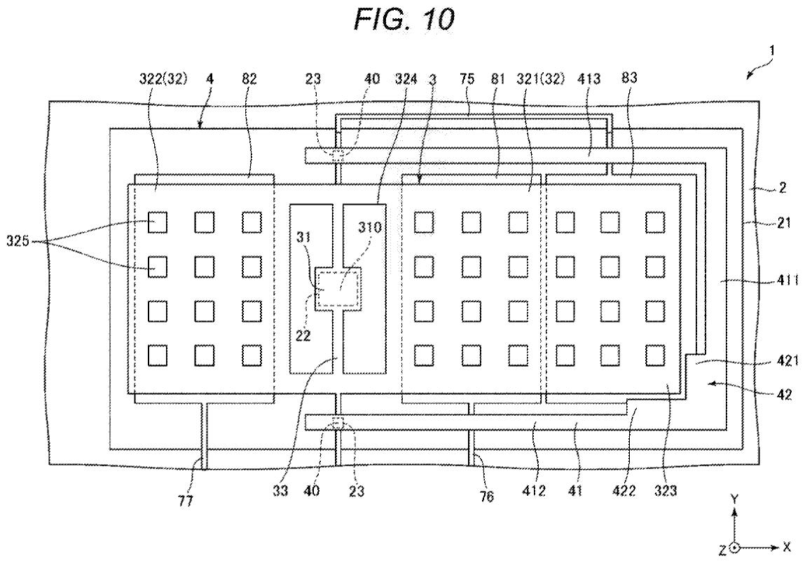

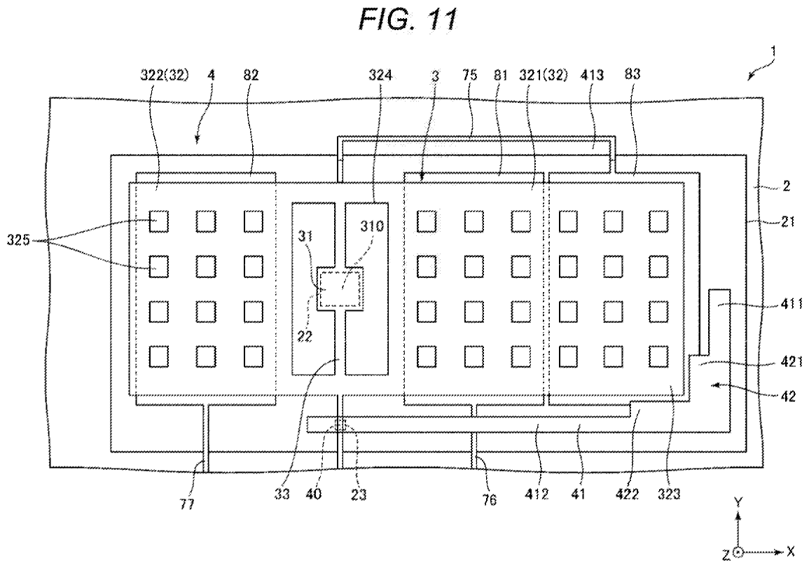

In this embodiment, the supporting section 41 of the stopper 4 is formed in a frame shape surrounding the sensor element 3. However, the supporting section 41 is not limited to this. For example, as shown in FIG. 10, the supporting section 41 may be formed in a U shape disposed to surround only the first movable section 321, specifically, a shape including a portion 411 located at the X-axis direction plus side of the first movable section 321 and extending in the Y-axis direction, a portion 412 extending from one end portion of the portion 411 to the X-axis direction minus side, and a portion 413 extending from the other end portion of the portion 411 to the X-axis direction minus side. The stopper joining regions 40 may be located at both end portions of the supporting section 41. With such a configuration, compared with this embodiment, it is possible to achieve a reduction in the size of the stopper 4. For example, as shown in FIG. 11, the supporting section 41 may be formed in an L shape disposed to surround only a half of the first movable section 321, specifically, a shape including the portion 411 located at the X-axis direction plus side of the first movable section 321 and extending in the Y-axis direction and the portion 412 extending from one end portion of the portion 411 to the X-axis direction minus side. The stopper joining region 40 may be located at one end portion of the supporting section 41. With such a configuration, compared with this embodiment, it is possible to achieve a reduction in the size of the stopper 4. Since there is only one stopper joining region 40, the stopper 4 is much less easily affected by the warp of the substrate 2.

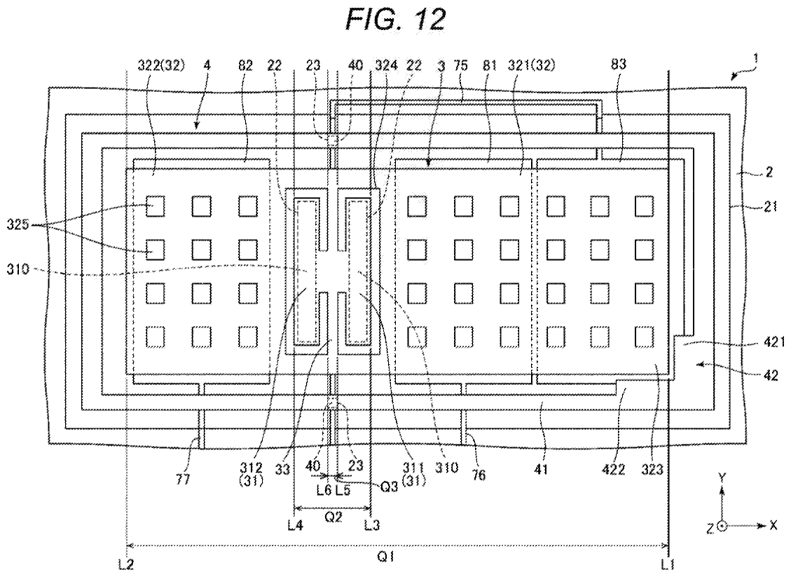

The fixed section 31 is not particularly limited. For example, as shown in FIG. 12, the fixed section 31 may include a first fixed section 311 located at one side with respect to the swing axis J and a second fixed section 312 located at the other side. The fixed section 31 may be joined to the first mount 22 by the respective first and second fixed sections 311 and 312. By adopting such a shape, the area of the fixed section joining region 310 can be further increased. Joining strength of the sensor element 3 and the substrate 2 increases.

### Second Embodiment

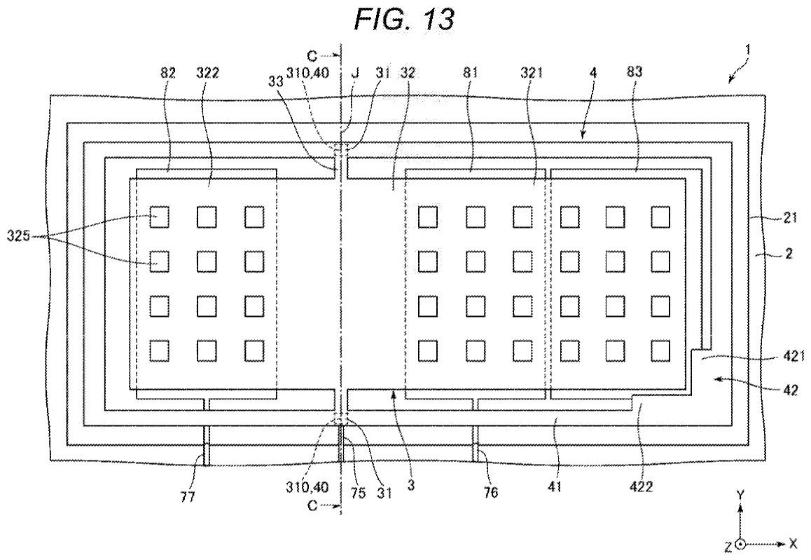

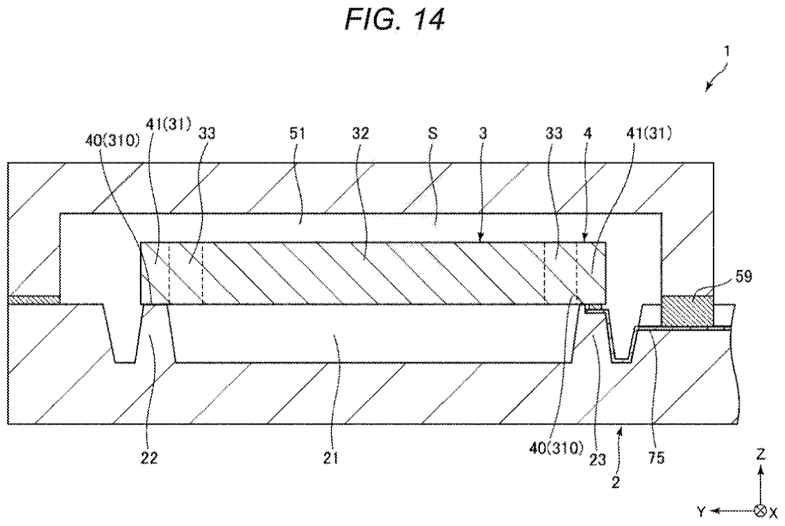

FIG. 13 is a plan view showing an inertial sensor according to a second embodiment. FIG. 14 is a sectional view taken along a C-C line in FIG. 13.

This embodiment is the same as the first embodiment except that the configuration of the sensor element 3 is different. In the following explanation, concerning this embodiment, differences from the first embodiment are mainly explained. Explanation concerning similarities is omitted. In FIG. 13, the same components as the components in the first embodiment are denoted by the same reference numerals and signs.

As shown in FIGS. 13 and 14, in the inertial sensor 1 in this embodiment, the sensor element 3 and the stopper 4 are integrally formed. A pair of fixed sections 31 is located at the outer side of the movable body 32 and provided across the movable body 32. The fixed sections 31 are formed in common with the supporting section 41 of the stopper 4. In other words, the fixed sections 31 are configured from a part of the supporting section 41. The fixed section joining regions 310, which are joining regions of the fixed sections 31 and the substrate 2, also function as the stopper joining regions 40, which are the joining regions of the stopper 4 and the substrate 2. That is, the fixed section joining regions 310 and the stopper joining regions 40 are present in the same places. Therefore, the stopper joining regions 40 can be brought closer to the fixed section joining regions 310. The positional deviation between the stopper main body 42 and the movable body 32 is more effectively suppressed. Therefore, the stopper 4 can more surely exert the function of the stopper 4 irrespective of the warp of the substrate 2. It is also possible to achieve a reduction in the size of the inertial sensor 1.

In this way, in the inertial sensor 1 in this embodiment, the stopper 4 is integral with the fixed sections 31. The fixed section joining regions 310 where the fixed sections 31 and the substrate 2 are joined also function as the stopper joining regions 40. Therefore, the stopper joining regions 40 can be brought closer to the fixed section joining regions 310. The positional deviation between the stopper main body 42 and the movable body 32 is more effectively suppressed. Therefore, the stopper 4 can more surely exert the function of the stopper 4 irrespective of the warp of the substrate 2. It is also possible to achieve a reduction in the size of the inertial sensor 1.

As explained above, the fixed sections 31 are located at the outer side of the movable body 32 in the plan view. Consequently, it is easier to integrate the fixed sections 31 and the stopper 4.

According to the second embodiment explained above, it is possible to exert the same effects as the effects in the first embodiment.

### Third Embodiment

FIG. 15 is a plan view showing a smartphone functioning as an electronic device according a third embodiment of the present disclosure.

An electronic device according to the present disclosure is applied to a smartphone 1200 shown in FIG. 15. The inertial sensor 1 and a control circuit 1210 configured to perform control based on a detection signal output from the inertial sensor 1 are incorporated in the smartphone 1200. Detection data detected by the inertial sensor 1 is transmitted to the control circuit 1210. The control circuit 1210 can recognize a posture and a behavior of the smartphone 1200 from the received detection data, change a display image displayed on a display section 1208, emit warning sound and sound effects, and drive a vibration motor to vibrate a main body.

Such a smartphone 1200 functioning as the electronic device includes the inertial sensor 1 and the control circuit 1210 configured to perform control based on a detection signal output from the inertial sensor 1. Therefore, the smartphone 1200 can enjoy the effects of the inertial sensor 1 explained above and can exert high reliability.

The electronic device according to the present disclosure can be applied to, besides the smartphone 1200, for example, a personal computer, a digital still camera, a tablet terminal, a watch, a smartwatch, an inkjet printer, a laptop personal computer, a television, a wearable terminal such as an HMD (head mounted display), a video camera, a video tape recorder, a car navigation device, a pager, an electronic notebook, an electronic dictionary, an electric calculator, an electronic game machine, a word processor, a work station, a video phone, a television monitor for crime prevention, an electronic binocular, a POS terminal, a medical device, a fish finder, various measuring devices, a device for a mobile terminal base station, meters for an automobile, an airplane, and a ship, a flight simulator, and a network server.

### Fourth Embodiment

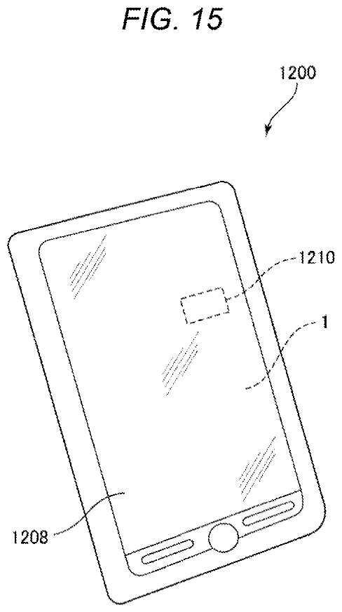

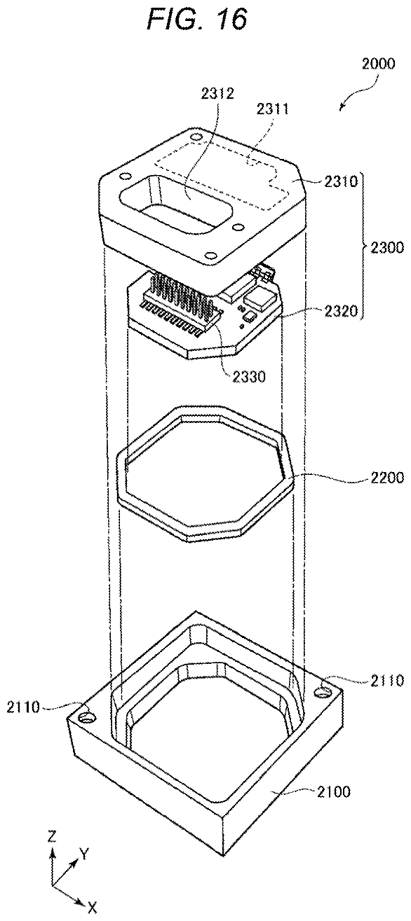

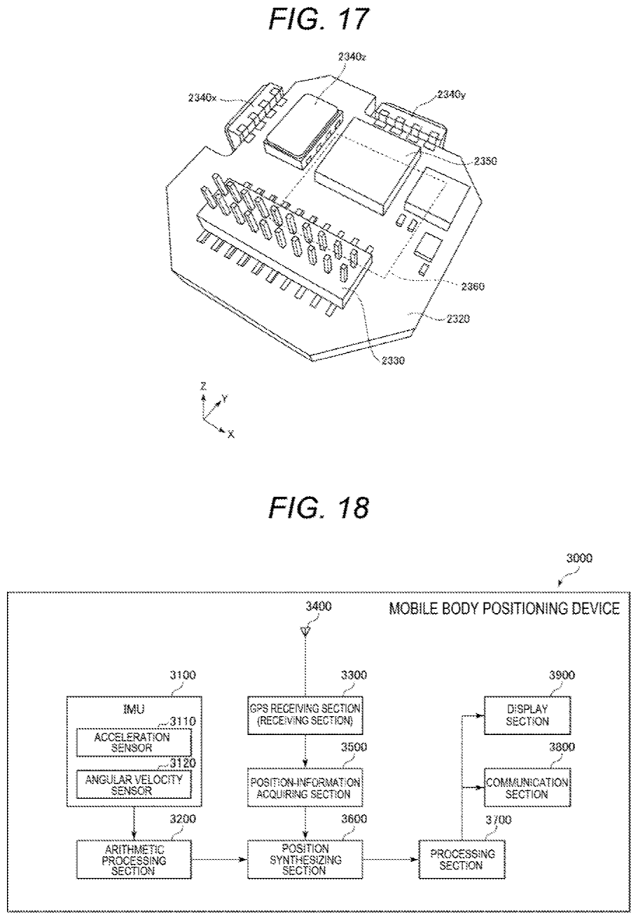

FIG. 16 is an exploded perspective view showing an inertial measurement unit functioning as an electronic device according to a fourth embodiment of the present disclosure. FIG. 17 is a perspective view of a substrate included in the inertial measurement unit shown in FIG. 16.

An inertial measurement unit (IMU) 2000 functioning as the electronic device shown in FIG. 16 is an inertial measurement unit that detects a posture and a behavior of a mounting apparatus such as an automobile or a robot. The inertial measurement unit 2000 functions as a six-axis motion sensor including a three-axis acceleration sensor and a three-axis angular velocity sensor.

The inertial measurement unit 2000 is a rectangular parallelepiped, a plane shape of which is a substantial square. Screw holes 2110 functioning as fixing sections are formed near vertexes in two places located in a diagonal direction of the square. The inertial measurement unit 2000 can be fixed to a mounting surface of a mounting body such as an automobile by inserting two screws through the screw holes 2110 in the two places. The inertial measurement unit 2000 can be reduced to a size mountable on, for example, a smartphone or a digital camera by selecting components and changing design.

The inertial measurement unit 2000 includes an outer case 2100, a joining member 2200, and a sensor module 2300. The joining member 2200 is interposed on the inside of the outer case 2100 to insert the sensor module 2300. Like the entire shape of the inertial measurement unit 2000, the external shape of the outer case 2100 is a rectangular parallelepiped, a plane shape of which is a substantial square. The screw holes 2110 are respectively formed near vertexes in two places located in a diagonal direction of the square. The outer case 2100 is box-like. The sensor module 2300 is housed on the inside of the outer case 2100.

The sensor module 2300 includes an inner case 2310 and a substrate 2320. The inner case 2310 is a member that supports the substrate 2320. The inner case 2310 is formed in a shape fit on the inside of the outer case 2100. A recess 2311 for preventing contact with the substrate 2320 and an opening 2312 for exposing a connector 2330 explained below are formed in the inner case 2310. Such an inner case 2310 is joined to the outer case 2100 by the joining member 2200. The substrate 2320 is joined to the lower surface of the inner case 2310 by an adhesive.

As shown in FIG. 17, a connector 2330, an angular velocity sensor 2340z configured to detect angular velocity around the Z axis, an acceleration sensor 2350 configured to detect accelerations in axial directions of the X axis, the Y axis, and the Z axis, and the like are mounted on the upper surface of the substrate 2320. An angular velocity sensor 2340x configured to detect angular velocity around the X axis and an angular velocity sensor 2340y configured to detect angular velocity around the Y axis are mounted on side surfaces of the substrate 2320. The inertial sensor according to the present disclosure can be used as the acceleration sensor 2350.

A control IC 2360 is mounted on the lower surface of the substrate 2320. The control IC 2360 is an MCU (Micro Controller Unit) and controls the sections of the inertial measurement unit 2000. A program specifying order and content for detecting acceleration and angular velocity, a program for digitizing detection data and incorporating the detection data in packet data, accompanying data, and the like are stored in a storing section. Besides, a plurality of electronic components are mounted on the substrate 2320.

### Fifth Embodiment

FIG. 18 is a block diagram showing an entire system of a vehicle positioning device functioning as an electronic device according to a fifth embodiment of the present disclosure. FIG. 19 is a diagram showing action of the vehicle positioning device shown in FIG. 18.

A vehicle positioning device 3000 shown in FIG. 18 is a device used while being amounted on a vehicle to perform positioning of the vehicle. The vehicle is not particularly limited and may be any one of a bicycle, an automobile, a motorbike, a train, an airplane, a ship, and the like. In this embodiment, a four-wheel automobile is used as the vehicle.

The vehicle positioning device 3000 includes an inertial measurement unit (IMU) 3100, an arithmetic processing section 3200, a GPS receiving section 3300, a reception antenna 3400, a position-information acquiring section 3500, a position synthesizing section 3600, a processing section 3700, a communication section 3800, and a display section 3900. As the inertial measurement unit 3100, for example, the inertial measurement unit 2000 explained above can be used.

The inertial measurement unit 3100 includes a three-axis acceleration sensor 3110 and a three-axis angular velocity sensor 3120. The arithmetic processing section 3200 receives acceleration data output from the acceleration sensor 3110 and angular velocity data output from the angular velocity sensor 3120, performs inertial navigation arithmetic processing on these data, and outputs inertial navigation positioning data including acceleration and a posture of the vehicle.

The GPS receiving section 3300 receives, with the reception antenna 3400, a signal transmitted from a GPS satellite. The position-information acquiring section 3500 outputs, based on the signal received by the GPS receiving section 3300, GPS positioning data representing a position (latitude, longitude, and altitude), speed, and a direction of the vehicle positioning device 3000. The GPS positioning data also includes status data indicating a reception state, reception time, and the like.

The position synthesizing section 3600 calculates, based on the inertial navigation positioning data output from the arithmetic processing section 3200 and the GPS positioning data output from the position-information acquiring section 3500, a position of the vehicle, specifically, in which position on the ground the vehicle is traveling. For example, even if the position of the vehicle included in the GPS positioning data is the same, if the posture of the vehicle is different because of the influence of inclination θ or the like of the ground as shown in FIG. 19, the vehicle is traveling in a different position on the ground. Therefore, an accurate position of the vehicle cannot be calculated with only the GPS positioning data. Therefore, the position synthesizing section 3600 calculates, using the inertial navigation positioning data, in which position on the ground the vehicle is traveling.

Position data output from the position synthesizing section 3600 is subjected to predetermined processing by the processing section 3700 and displayed on the display section 3900 as a positioning result. The positioning data may be transmitted to an external device by the communication section 3800.

### Sixth Embodiment

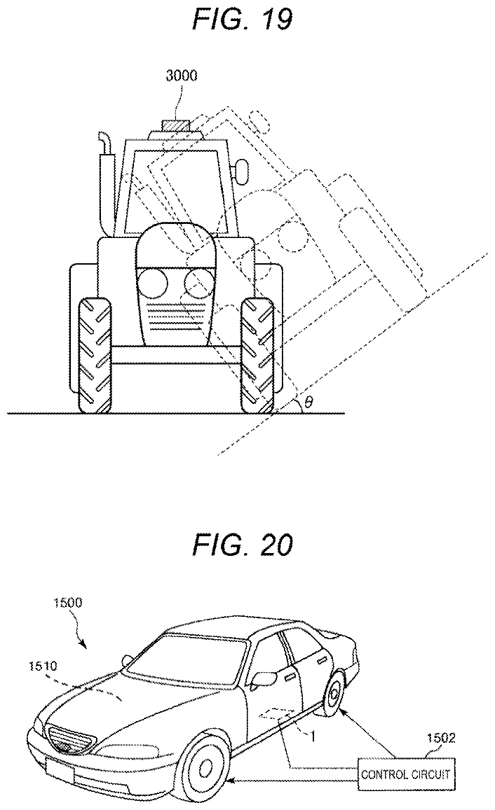

FIG. 20 is a perspective view showing a vehicle according to a sixth embodiment of the present disclosure.

An automobile 1500 shown in FIG. 20 is an automobile applied with a vehicle of the present disclosure. In FIG. 20, the automobile 1500 includes a system 1510, which is at least anyone of an engine system, a brake system, and a keyless entry system. The inertial sensor 1 is incorporated in the automobile 1500. A posture of an automobile body can be detected by the inertial sensor 1. A detection signal of the inertial sensor 1 is supplied to a control circuit 1502. The control circuit 1502 can control the system 1510 based on the signal.

In this way, the automobile 1500 functioning as the vehicle includes the inertial sensor 1 and the control circuit 1502 configured to perform control based on the detection signal output from the inertial sensor 1. Therefore, the automobile 1500 can enjoy the effects of the inertial sensor 1 explained above and can exert high reliability.

Besides, the inertial sensor 1 can be widely applied to a car navigation system, a car air conditioner, an antilock brake system (ABS), an airbag, a tire pressure monitoring system (TPMS), an engine control, and an electronic control unit (ECU) such as a battery monitor of a hybrid automobile or an electric automobile. The vehicle is not limited to the automobile 1500. The vehicle can be applied to, for example, an airplane, a rocket, an artificial satellite, a ship, an AGV (automatic guided vehicle), a bipedal walking robot, an unmanned aircraft such as a drone, and the like.

The inertial sensor, the electronic device, and the vehicle according to the present disclosure are explained above based on the embodiments shown in the figures. However, the present disclosure is not limited to the inertial sensor, the electronic device, and the vehicle. The components of the sections can be replaced with any components having the same functions. Any other components may be added to the present disclosure. The embodiments explained above may be combined as appropriate.

What is claimed is:

1. An inertial sensor comprising:
when three axes orthogonal to one another are represented as an X axis, a Y axis, and a Z axis,
a substrate;
a movable body configured to swing around a swing axis extending along the Y axis;
a fixed section configured to support the movable body and fixed to the substrate; and
a stopper fixed to the substrate and configured to come into contact with the movable body to thereby restrict rotational displacement of the movable body around the Z axis, wherein
a stopper joining region where the stopper and the substrate are jointed is located, in a plan view from a direction along the Z axis, within a first region formed by extending the movable body in a direction along the Y axis, and
a portion of the stopper located outside the first region is separated from the substrate.

2. The inertial sensor according to claim 1, wherein
the stopper joining region is located, in the plan view from the direction along the Z axis, within a second region formed by extending the fixed section in the direction along the Y axis, and
a portion of the stopper located outside the second region is separated from the substrate.

3. The inertial sensor according to claim 2, wherein the stopper joining region overlaps the swing axis in the plan view from the direction along the Z axis.

4. The inertial sensor according to claim 1, further comprising a beam configured to couple the movable body and the fixed section, wherein
the stopper joining region is located, in the plan view from the direction along the Z axis, within a third region formed by extending the beam in the direction along the Y axis, and
a portion of the stopper located outside the third region is separated from the substrate.

5. The inertial sensor according to claim 1, wherein
the stopper is integral with the fixed section, and
a fixed section joining region where the fixed section and the substrate are joined also functions as the stopper joining region.

6. The inertial sensor according to claim 5, wherein the fixed section is located at the outer side of the movable body.

7. The inertial sensor according to claim 1, wherein
the stopper is separate from the fixed section, and
the stopper joining region is present in a position different from a fixed section joining region where the fixed section and the substrate are joined.

8. The inertial sensor according to claim 7, wherein the fixed section is located at an inner side of the movable body.

9. The inertial sensor according to claim 1, wherein
the movable body includes a first movable section and a second movable section having a rotational moment around the swing axis different from the rotational moment of the first movable section, the first movable section and the second movable section being disposed across the swing axis, and
the inertial sensor further comprises:
a first fixed detection electrode disposed on the substrate and opposed to the first movable section; and
a second fixed detection electrode disposed on the substrate and opposed to the second movable section.

10. An electronic device comprising:
the inertial sensor according to claim 1; and
a control circuit configured to perform control based on a detection signal output from the inertial sensor.

11. A vehicle comprising:
the inertial sensor according to claim 1; and
a control circuit configured to perform control based on a detection signal output from the inertial sensor.
